(19) United States
(12) Patent Application Publication
(10) Pub. No.: US 2012/0212215 A1
(43) Pub. Date: Aug. 23, 2012

(54) METHOD AND APPARATUS FOR ESTIMATING ROTOR ANGLE OF SYNCHRONOUS RELUCTANCE MOTOR

(75) Inventor: Matti VEIJANEN, Espoo (FI)

(73) Assignee: ABB OY, Helsinki (FI)

(21) Appl. No.: 13/401,328

(22) Filed: Feb. 21, 2012

(30) Foreign Application Priority Data
Feb. 22, 2011 (EP) 11155284.0

(51) Int. Cl. G01B 7/30

(52) U.S. Cl. 324/207.22

(57) ABSTRACT

Exemplary embodiments are directed to estimating a rotor angle of a synchronous reluctance motor. The motor has a stator and a rotor. A stator flux and a stator current are determined. Two orthogonal stator flux components in a stator reference frame are calculated from the stator flux. Two orthogonal stator current components in the stator reference frame are calculated from the stator current. Two rotor orientation vectors are then calculated using a known rotor direct and quadrature axis inductance components, the stator flux components, and the stator current components. A rotor angle is estimated based on the rotor orientation vectors.

### RELATED APPLICATION

This application claims priority under 35 U.S.C. §119 to European Patent Application No. 11155284.0 filed in Europe on Feb. 22, 2011, the entire content of which is hereby incorporated by reference in its entirety.

### FIELD

The present disclosure relates to synchronous motors, such as, estimating a rotor angle of a synchronous reluctance motor (SYRM).

### BACKGROUND INFORMATION

A synchronous motor is an AC motor having a rotor and a stator, distinguished by the rotor spinning synchronously with stator frequency. There are two major types of synchronous motors: non-excited and direct-current excited. Reluctance motors belong to the former group.

When operating a synchronous motor, an angle and/or speed of a rotor of the motor should be known. The angle and speed can, for instance, be detected by using a position sensor. The position sensor, however, may add costs and unreliability to the system.

### SUMMARY

An exemplary method of estimating a rotor orientation of a synchronous reluctance motor is disclosed, the motor having a stator and a rotor, wherein an inductance of the rotor in rotor coordinates is represented by a known rotor quadrature axis inductance component (L_{q}) and a known rotor direct axis inductance component (L_{d}), and wherein the method comprising: determining a stator flux and a stator current; forming a first estimate of the rotor orientation based on the stator flux, the stator current, and one of the known rotor inductance components; forming a second estimate of the rotor orientation based on the stator flux, the stator current, and the other of the known rotor inductance components; determining values for weighting parameters; and determining the rotor orientation based on the first estimate and the second estimate, wherein the values of the first and second estimates are weighted based on the weighting parameters.

An exemplary apparatus adapted to be connected to a synchronous reluctance motor is disclosed, the motor having a stator and a rotor, and the apparatus comprising: means for determining a stator flux and a stator current, wherein an inductance of the rotor in rotor coordinates is represented by a known rotor quadrature axis inductance component (L_{q}) and a known rotor direct axis inductance component (L_{d}); means for forming a first estimate of the rotor orientation based on the stator flux, the stator current, and one of the known rotor inductance components; means for forming a second estimate of the rotor orientation based on the stator flux, the stator current, and the other of the known rotor inductance components; means for determining values for weighting parameters; and means for determining the rotor orientation based on the first estimate and the second estimate, wherein the values of the first and second estimates are weighted based on the weighting parameters.

An exemplary computer readable medium having a program code stored thereon, which causes a computer to execute a method of estimating a rotor orientation of a synchronous reluctance motor is disclosed, the motor having a stator and a rotor, wherein an inductance of the rotor in rotor coordinates is represented by a known rotor quadrature axis inductance component (L_{q}) and a known rotor direct axis inductance component (L_{d}), and wherein the method comprising: determining a stator flux and a stator current; forming a first estimate of the rotor orientation based on the stator flux, the stator Current, and one of the known rotor inductance components; forming a second estimate of the rotor orientation based on the stator flux, the stator current, and the other of the known rotor inductance components, determining values for weighting parameters; and determining the rotor orientation based on the first estimate and the second estimate, wherein the values of the first and second estimates are weighted based on the weighting parameters.

### BRIEF DESCRIPTION OF THE DRAWINGS

In the following, the disclosure will be described in greater detail by means of exemplary embodiments with reference to the accompanying drawings, in which

FIGS. 1a, 1b, and 1c illustrate loci of d-axis oriented rotor orientation vectors and stator current as functions of a rotor angle in accordance with an exemplary embodiment;

FIGS. 2a and 2b illustrate example weighting functions for rotor angle estimates in accordance with an exemplary embodiment;

FIG. 3 illustrates a simplified diagram of a PLL adapted for estimating the rotor speed of a synchronous reluctance motor in accordance with an exemplary embodiment; and

FIG. 4 illustrates an arrangement for determining the angle and speed of a rotor in accordance with an exemplary embodiment.

### DETAILED DESCRIPTION

In exemplary embodiments of the present disclosure, the angle and the speed of the rotor of the SYRM can be determined by using a mathematical motor model utilizing saliency of the rotor. The saliency of the rotor has to be known. When direct (d) axis and quadrature (q) axis inductances are known, the rotor position can be derived from the computational voltage and current models of the SYRM, provided there is a stator flux in the motor. For example, estimators using the direct (d) axis and quadrature (q) axis inductances can be formed. By weighting the estimator results based on the rotor orientation in regard to the stator flux, accuracy of the rotor angle estimate may be improved.

In machine types like permanent magnet motors and induction motors, a rotor flux component may not be unambiguously determinable from a stator voltage integral. There is no permanent magnet flux in a SYRM, so the stator flux and the stator current are directly bound to each other by an inductance relation in rotor coordinates.

The inductance in the rotor coordinates is represented by two components: a d-axis inductance component L_{d} and a q-axis inductance component L_{q}. A difference between these two parameters is a basis for operation of a reluctance motor.

If the inductance components of a synchronous reluctance motor are known, they can be used in rotor orientation estimation. The stator flux and the stator current are first determined. A first estimate of the rotor orientation may then be formed based on the stator flux, the stator current, and a known rotor inductance component. A direct axis oriented rotor orientation vector \vec{θ}_{d} may be calculated from a difference between the stator flux \vec{ψ}ₛ and a product of an inductance component L_{q} and the stator current \vec{i}ₛ, as follows:

\vec{θ}_{d}=±(\vec{ψ}ₛ−L_{q}\vec{i}ₛ). (1)

The ± sign in Equation 1 represents two different rotor orientations related to a same pole. In general, there is no difference between these orientations, owing to the lack of a permanent magnet induced flux, and therefore in some embodiments the signs can be omitted.

Similarly, a quadrature axis oriented rotor orientation vector \vec{θ}_{q} may be calculated using the other inductance component L_{d}, as follows:

\vec{θ}_{q}=±(\vec{ψ}ₛ−L_{d}\vec{i}ₛ). (2)

In some embodiments, the first estimate may be formed based on the orientation vector of Equation 1 or 2. The rotor orientation may then be determined based on the first estimate.

The estimated rotor orientation may also be represented in the form of an angle. The vectors of Equations 1 and 2 may be used to estimate a rotor orientation angle. The first estimate may be determined based on a ratio between an x component and a y component of an orientation vector \vec{θ}_{d} or \vec{θ}_{q}, for instance, as follows:

$${θ}_{est} = arctan ( \frac{{θ}_{x}}{{θ}_{y}} ) + \frac{π}{2} \pm \frac{π}{2} , \qquad ( 3 )$$

where θₑₛₜ is the estimated rotor orientation angle, θₓ and θ_{y} are the x and y components of an orientation vector. The ± sign represents two different rotor orientation angles related to a same pole.

A second estimate of the rotor orientation may be formed based on the stator flux, the stator current, and the other known rotor inductance component. In other words, another orientation vector may be formed. Similarly to the first estimate, the second estimate may be represented by an orientation vector. The two orientation vectors may be formed such that they have the same orientation. The second estimate may also be represented by an angle determined based on a ratio between an x component and a y component of the orientation vector.

An exemplary embodiment for implementing an exemplary method of the disclosure is disclosed below. After the stator flux and stator current are determined, two orthogonal stator flux components in a stator reference frame are calculated from the stator flux, and two orthogonal stator current components in the stator reference frame are calculated from the stator current. Then, estimates of the rotor orientation may be formed by using the stator flux components, the stator current components, and the known rotor inductance components.

By using Equations 1 and 2, it is possible to calculate two rotor orientation vectors: a first rotor orientation vector and a second rotor orientation vector \vec{θ}_{q,2}. They can, for instance, be calculated as follows:

\vec{θ}_{d,1}=1±(ψₓ−L_{q}iₓ+j(ψ_{y}−L_{q}i_{y})), (4)

\vec{θ}_{d,2}=±(L_{d}i_{y}−ψ_{y}+j(ψₓ−L_{d}iₓ)) (5)

ψₓ and ψ_{y} are two orthogonal stator flux components in the stator reference frame, calculated from the stator flux \vec{ψ}ₛ. iₓ and i_{y} are two orthogonal stator current components in the stator reference frame, calculated from the stator current \vec{i}ₛ. In Equation 5, the quadrature oriented vector of Equation 2 is rotated by 90 degrees by switching the real part and the imaginary part of the vector, and by multiplying the new real part by −1.

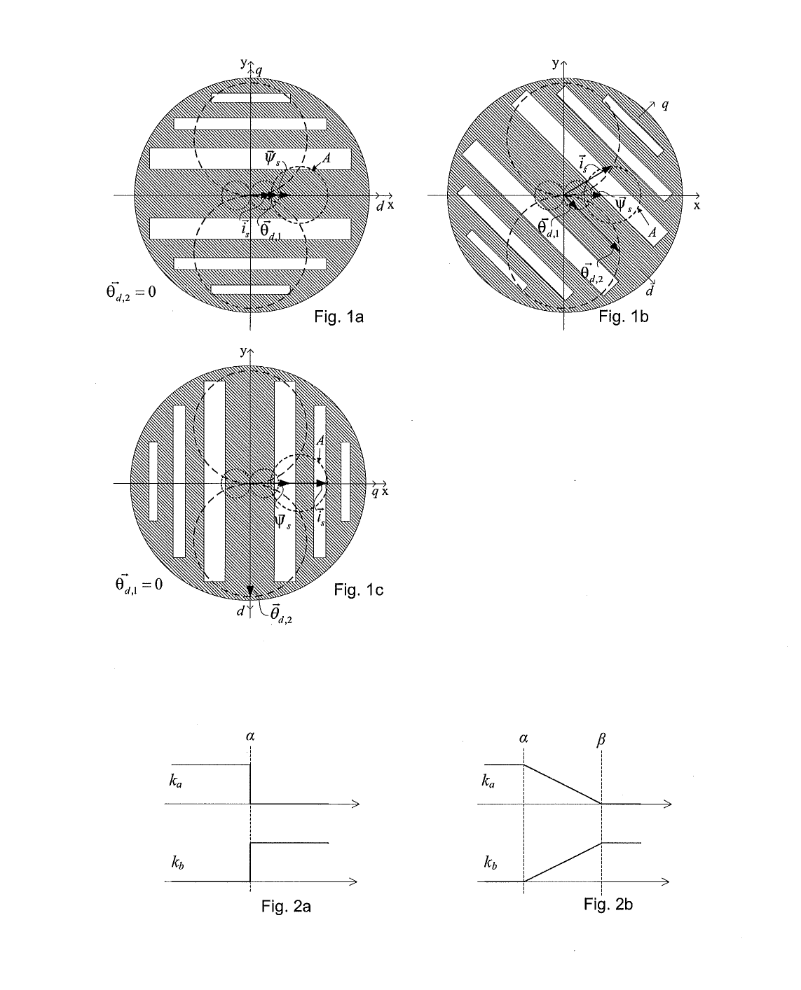

The two rotor orientation vectors in Equations 4 and 5 are always aligned with the rotor d-axis. FIGS. 1a, 1b, and 1c illustrate loci of d-axis oriented rotor orientation vectors and stator current as functions of a rotor angle in accordance with an exemplary embodiment. As shown in FIGS. 1a, 1b, and 1c, the loci of the d-axis oriented rotor orientation vectors and the stator current as functions of a rotor angle. Estimators using q-axis oriented vectors may also be used to determine the rotor angle.

As the rotor turns in respect of the stator flux \vec{ψ}ₛ, the stator current vector \vec{i}ₛ end follows a circle A. The circle A has its center aligned with the stator flux vector \vec{ψ}ₛ. In FIGS. 1a, 1b, and 1c, the stator flux \vec{ψ}ₛ is kept constant at x-axis, d-axis inductance component L_{d} is 2, and q-axis inductance component L_{q} is 0.5. The stator current vector \vec{i}ₛ end makes a full round along the circle A as the rotor rotates a full electrical angle. In the case of a single pole-pair motor, as in FIGS. 1a, 1b, and 1c, this means that the stator current vector \vec{i}ₛ end makes two full rounds as the rotor mechanically rotates a full round.

The d-axis oriented first rotor orientation vector \vec{θ}_{d,1} has a zero length point when the stator flux is aligned with the q-axis and the d-axis oriented second rotor orientation vector \vec{θ}_{d,2} has a zero length point when the stator flux is aligned with the d-axis. In a similar manner, a first and a second rotor orientation vector aligned with q-axis may also be calculated.

If necessary, a rotor angle may be determined based on a ratio between an x component and a y component of the first or the second rotor orientation vector. The orientation vectors can be d- or q-axis oriented. For instance, the rotor direct axis angle can be calculated from the rotor orientation vectors \vec{θ}_{d,1} and \vec{θ}_{d,2} with following rotor orientation angle estimators θ_{est,1} and θ_{est,2} respectively:

$$\begin{matrix}{θ}_{est , 1} = arctan ( \frac{{ψ}_{y} - {L}_{q} {i}_{y}}{{ψ}_{x} - {L}_{q} {i}_{x}} ) + \frac{π}{2} \pm \frac{π}{2} , & ( 6 ) \\ {θ}_{est , 2} = arctan ( \frac{{ψ}_{x} - {L}_{d} {i}_{x}}{{L}_{d} {i}_{y} - {ψ}_{y}} ) + \frac{π}{2} \pm \frac{π}{2} . & ( 7 )\end{matrix}$$

The numerators and the denominators of these estimators are the y component and x components of the d-axis oriented rotor orientation vectors \vec{θ}_{d,1}, and \vec{θ}_{d,2}. Similarly to equation 3, the ± sign represents two different rotor orientation angles related to a same pole.

In theory, the estimators should give perfect orientation estimates in all other orientations but the zero length orientations. In practice, the parameter errors related to L_{d} and L_{q} may significantly affect the accuracy anywhere near the zero length orientations. As illustrated in FIGS. 1a, 1b, and 1c, the rotor orientation angle estimator θ_{est,1} is more accurate when the stator flux is near the d-axis of the rotor. Correspondingly, the estimator θ_{est,2} is more accurate when the stator flux is near the q-axis of the rotor.

An angle between the stator flux and the rotor direct axis may change, for instance because of a change in a load. As a response to the change in the load, the torque may have to change. In order to produce a different torque, an angle between the stator flux and the rotor direct axis may have to be changed. As this angle changes, the rotor orientation vectors may, at some point, have zero lengths, thus affecting the accuracy of the estimator using the vector.

Therefore, in order to improve the accuracy, the rotor angle may be estimated based on two estimates. A first estimate of the rotor orientation may be formed based on the stator flux components, the stator current components, and one of the known rotor inductance components. The rotor orientation vector \vec{θ}_{d,1} of Equation 4 may, for instance, produce the first estimate.

A second estimate of the rotor orientation may be formed based on the stator flux components, the stator current components, and the other known rotor inductance component. The rotor orientation vector \vec{θ}_{d,2} of Equation 5 may, for instance, produce the second estimate. Thus, the two estimates use different rotor orientation vectors having different zero length orientations. Even if a rotor orientation vector related to one of the estimates is at its zero length orientation, the other estimate gives an accurate value for the rotor angle.

The first rotor orientation vector \vec{θ}_{d,1} and the second rotor orientation vector \vec{θ}_{d,2} may be used together for estimating the rotor orientation. As the inductance components are not equal, maximum lengths of the orientation vectors using different inductance components are not equal. The length of a vector may be corrected using a correction parameter. Thus, a third orientation vector \vec{θ}_{d,sum} may be formed, for instance, as follows:

\vec{θ}_{d,sum}=\vec{θ}_{d,1}+l\vec{θ}_{d,2}, (8)

where l is a correction parameter for which a value can be determined, for instance, based on a ratio between the rotor inductance components. When both estimators are used together, the correct signs may have to be selected in order to have consistent orientations in every quarter of the rotor coordinates.

An orientation of the rotor can also be used to decide how to use the two estimates. The orientation may, for instance, be represented by an angle between the rotor direct axis and the stator flux, or by an angle between the rotor direct axis and the stator current. This angle may, for instance, be calculated using a rotor orientation estimate calculated previously. Values for one or more weighting parameters may then be calculated based on the orientation of the rotor. The estimates may then be weighted based on the weighting parameters. The weighted values of the estimates may then, for instance, be added together to estimate the rotor orientation. The weighting parameters may also be calculated by other means. For instance, the lengths of the orientation vectors, or a ratio between the lengths of the vectors, may be used.

FIGS. 2a and 2b illustrate example weighting functions for rotor angle estimates in accordance with an exemplary embodiment. FIG. 2a shows an example of weighting functions for two weighting parameters kₐ and k_{b}. The parameters kₐ and k_{b} are used with the first and the second estimates, respectively, to produce a rotor orientation estimate. The first weighting parameter t kₐ has the value of one when an absolute value of the angle between the rotor direct axis and the stator flux, representing the rotor orientation in regard of stator flux, is less than an angle α. Otherwise the first weight coefficient has the value of zero. The second weight coefficient k_{b} is zero when the absolute value of the angle between the rotor direct axis and the stator flux is less than the angle α, and one when the absolute value of the angle between the rotor direct axis and the stator flux exceeds the set angle α. In other words, if the absolute value of the angle between the rotor direct axis and the stator flux is less than the angle α, the rotor orientation estimate is based solely on the first estimate. Otherwise, only the second estimate is used to determine the rotor orientation.

Other weighting coefficient functions may also be used. As shown in FIG. 2b, a ratio between the weighting parameters kₐ and k_{b} changes linearly with the absolute value of the angle between the rotor direct axis and the stator flux, when between angles α and β. The final rotor orientation estimate may, for instance, be the sum of both estimates. In other words, between the angles α and β, both first and second estimate affect the final rotor orientation estimate. Also other, linear or nonlinear weighting coefficient functions may be used.

If the rotor is rotating at a speed that is not known, the speed can be estimated based on the estimated orientation. For instance, a speed estimate can simply be calculated from a time derivate of the rotor position. A simple phase locked loop (PLL) can also be utilized to obtain a filtered speed estimate from the rotor orientation estimate. Other methods may also be used to obtain a speed estimate from the estimated rotor orientation.

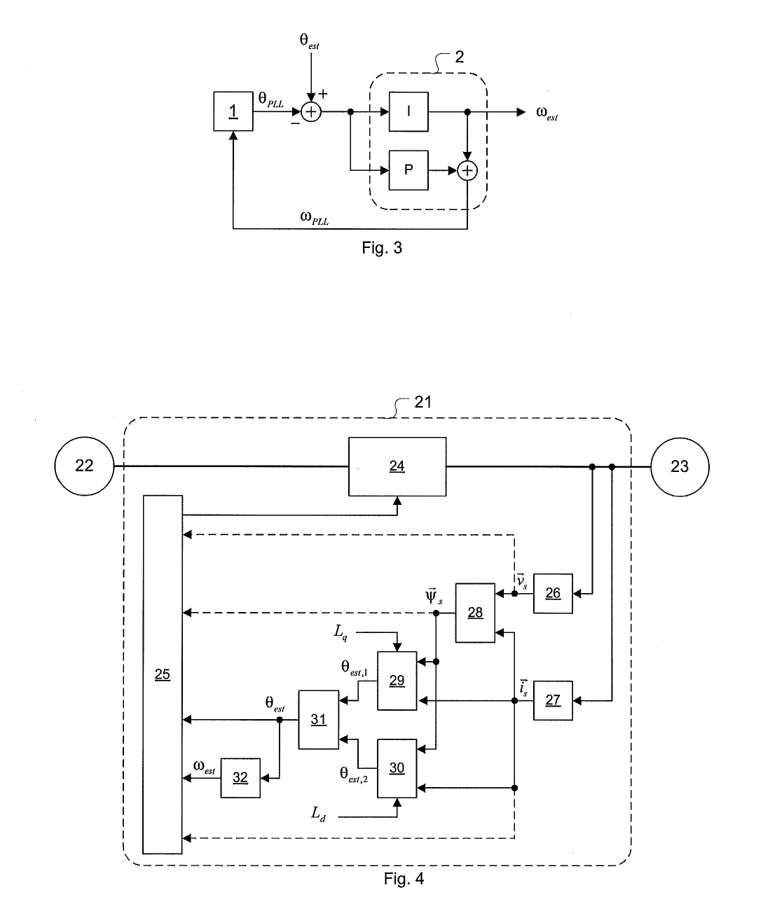

FIG. 3 illustrates a simplified diagram of a PLL adapted for estimating the rotor speed of a synchronous reluctance motor in accordance with an exemplary embodiment. FIG. 3 shows a simplified diagram of a PLL adapted for estimating the rotor speed of a synchronous reluctance motor based on the estimated rotor orientation θₑₛₜ.

The PLL calculates an estimate ωₑₛₜ for the rotor speed based on a difference between a feedback angle term θ_{PLL} and the rotor orientation angle θₑₛₜ. A value for a feedback angle term θ_{PLL} is calculated by integrating, using integrating means 1, the feedback speed term ω_{PLL}, for which a value is determined based on a difference between the feedback angle term θ_{PLL} and the rotor orientation angle θₑₛₜ. The value for a feedback speed term ω_{PLL} may, for instance, be determined using a PI controller 2, as in FIG. 2. An integrative part I of the PI-controller 2 is also used to produce the speed estimate ωₑₛₜ.

FIG. 4 illustrates an arrangement where an apparatus 21 is connected between a supplying grid 22 and a synchronous reluctance motor 23. The motor includes a stator and a rotor. A rotor quadrature axis inductance component L_{q} and a rotor direct axis inductance component L_{d} are known. The apparatus 21 is capable of controlling the motor 23, using a motor controller.

In FIG. 4, the apparatus 21 is a frequency converter and the motor controller is an inverter bridge 24. The inverter bridge 24 is controlled by a flux controller 25. Also other controllers, for instance a current controller, may be used. The flux controller 25 uses an estimated rotor orientation and speed as input parameters. The controller may, as in FIG. 4, use also other inputs, such as a stator current, a stator voltage or a stator flux.

In the arrangement, the stator flux and the stator current are determined in order to estimate the rotor orientation and speed. Thus, the apparatus includes a stator voltage measuring unit 26 and a stator current measuring unit 27. The stator current measuring unit 27 also calculates two orthogonal stator current components in the stator reference frame from the stator current.

The stator flux is then determined using a voltage model 28. The voltage model 28 calculates the flux as an integral of the stator voltage minus resistive losses. The voltage model 28 also calculates two orthogonal stator current components in the stator reference frame from the stator current.

The apparatus 21 includes a first rotor orientation estimator 29 and a second rotor orientation estimator 30. The first rotor orientation estimator 29 uses the stator flux components, the stator current components, and one of the known rotor inductance components as inputs. It produces a first estimate of the rotor orientation. The first rotor orientation estimator 29 may, for instance, calculate the d-axis oriented first rotor orientation vector by using the known rotor q-axis inductance component L_{q}, the stator flux components, and the stator current components, as defined in Equation 4. The first rotor orientation estimator 29 may use the orientation vector as the first estimate. Alternatively, it may use a rotor orientation angle calculated based on the d-axis oriented first rotor orientation vector, for instance as defined in equation 6, as the first estimate.

The second rotor orientation estimator 30 uses the stator flux components, the stator current components, and the other known rotor inductance component as inputs. It produces a second estimate of the rotor orientation. The second rotor orientation estimator 30 may calculate the d-axis oriented second rotor orientation vector by using the known rotor d-axis inductance component L_{d}, the stator flux components, and the stator current components, as defined in Equation 5. The first rotor angle estimator 30 may then use the second rotor orientation vector as the second estimate. Alternatively it may use a rotor orientation angle calculated based on the d-axis oriented second rotor orientation vector, for instance as defined in Equation 7, as the second estimate.

A weighting function unit 31 then uses outputs of the first and the second estimator. It determines values for weighting parameters, for instance, based on an absolute value of an angle between the rotor direct axis and the stator flux. The weighting function unit 31 then determines the rotor orientation based on the first estimate and the second estimate. The outputs of the first and second estimators are weighted based on the weighting parameters.

The apparatus also includes a rotor speed estimator 32. The estimator 32 estimates the rotor speed of a synchronous reluctance motor based on the rotor orientation. The method is similar to that disclosed in FIG. 3 and the above description related to FIG. 3. In the method, an initial value is first set for a feedback speed term. A value for a feedback angle term is then calculated by integrating the feedback speed term. An estimate for the rotor speed is determined based on a difference between the feedback angle term and the rotor orientation. A new value for the feedback speed term is determined based on a difference between the feedback angle term and the rotor orientation.

The method and related apparatus are described above with reference to the respective functions they perform according to exemplary embodiments. It is to be understood that one or more of these elements and functions can be implemented in a hardware configuration. For example, the respective components may comprise a computer processor configured to execute computer-readable instructions (e.g. computer-readable software), a non-volatile computer-readable recording medium, such as a memory element (e.g. ROM, flash memory, optical memory, etc.) configured to store such computer-readable instructions, and a volatile computer-readable recording medium (e.g. RAM) configured to be utilized by the computer processor as working memory while executing the computer-readable instructions. The methods and related apparatus may also be configured to sense, generate and/or operate in accordance with analog signals, digital signals and/or a combination of digital and analog signals to carry out their intended functions.

Thus, it will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

What is claimed is:

1. A method of estimating a rotor orientation of a synchronous reluctance motor having a stator and a rotor, wherein an inductance of the rotor in rotor coordinates is represented by a known rotor quadrature axis inductance component (L_{q}) and a known rotor direct axis inductance component (L_{d}), and wherein the method comprising:
determining a stator flux and a stator current;
forming a first estimate of the rotor orientation based on the stator flux, the stator current, and one of the known rotor inductance components;
forming a second estimate of the rotor orientation based on the stator flux, the stator current, and the other of the known rotor inductance components;
determining values for weighting parameters; and
determining the rotor orientation based on the first estimate and the second estimate, wherein the values of the first and second estimates are weighted based on the weighting parameters.

2. The method according to claim 1, wherein the value for the weighting parameter is determined based on an orientation represented by an angle between a rotor direct axis and the stator flux.

3. The method according to claim 1, wherein the value for the weighting parameter is determined based on an orientation represented by an angle between the rotor direct axis and the stator current.

4. The method according to claim 1, wherein the value for the weighting parameter is determined based on lengths of rotor orientation vectors.

5. The method according to claim 1, wherein determining the rotor orientation comprises:
determining a value for a correction parameter based on a ratio between the rotor inductance components; and
using the correction parameter to correct a length of an orientation vector.

6. The method according to claim 1, wherein forming the first estimate of the rotor angle comprises:
calculating a first rotor orientation vector based on the stator flux, the stator current, and one of the known rotor inductance components; and
forming a first estimate based on the first rotor orientation vector, and
wherein forming a second estimate of the rotor angle comprises:
calculating a second rotor orientation vector based on the stator flux, the stator current, and the known other rotor inductance component; and
forming the second estimate based on the second rotor orientation vector.

7. The method according to claim 1, wherein forming the first estimate of the rotor angle comprises
calculating a first rotor orientation vector based on the stator flux, the stator current, and one of the known rotor inductance components; and
forming a first estimate based on a ratio between an x component and an y component of the first rotor orientation vector, and
wherein forming a second estimate of the rotor angle comprises:
calculating a second rotor orientation vector based on the stator flux, the stator current, and the known other rotor inductance component; and
forming a second estimate based on a ratio between an x component and a y component of the second rotor orientation vector.

8. The method according to claim 1, comprising:
estimating a rotor speed of a synchronous reluctance motor based on the estimated rotor orientation.

9. The method according to claim 8, wherein estimating the rotor speed comprises:
setting a value for a feedback speed term;
calculating a value for a feedback angle term by integrating the feedback speed term;
determining an estimate for the rotor speed based on a difference between the feedback angle term and the estimated rotor orientation; and
determining a new value for a feedback speed term speed based on a difference between the feedback angle term and the estimated rotor orientation.

10. An apparatus adapted to be connected to a synchronous reluctance motor, the motor having a stator and a rotor, and the apparatus comprising:
means for determining a stator flux and a stator current, wherein an inductance of the rotor in rotor coordinates is represented by a known rotor quadrature axis inductance component (L_{q}) and a known rotor direct axis inductance component (L_{d});
means for forming a first estimate of the rotor orientation based on the stator flux, the stator current, and one of the known rotor inductance components;
means for forming a second estimate of the rotor orientation based on the stator flux, the stator current, and the other of the known rotor inductance components;
means for determining values for weighting parameters; and
means for determining the rotor orientation based on the first estimate and the second estimate, wherein the values of the first and second estimates are weighted based on the weighting parameters.

11. The method according to claim 2, wherein determining the rotor orientation comprises:
determining a value for a correction parameter based on a ratio between the rotor inductance components; and
using the correction parameter to correct a length of an orientation vector.

12. The method according to claim 2, wherein forming the first estimate of the rotor angle comprises:
calculating a first rotor orientation vector based on the stator flux, the stator current, and one of the known rotor inductance components; and
forming a first estimate based on the first rotor orientation vector, and
wherein forming a second estimate of the rotor angle comprises:
calculating a second rotor orientation vector based on the stator flux, the stator current, and the known other rotor inductance component; and
forming the second estimate based on the second rotor orientation vector.

13. The method according to claim 2, wherein forming the first estimate of the rotor angle comprises:
calculating a first rotor orientation vector based on the stator flux, the stator current, and one of the known rotor inductance components; and
forming a first estimate based on a ratio between an x component and an y component of the first rotor orientation vector, and
wherein forming a second estimate of the rotor angle comprises:
calculating a second rotor orientation vector based on the stator flux, the stator current, and the known other rotor inductance component; and
forming a second estimate based on a ratio between an x component and a y component of the second rotor orientation vector.

14. The method according to claim 2, comprising:
estimating a rotor speed of a synchronous reluctance motor based on the estimated rotor orientation.

15. The method according to claim 3, wherein determining the rotor orientation comprises:
determining a value for a correction parameter based on a ratio between the rotor inductance components; and
using the correction parameter to correct a length of an orientation vector.

16. The method according to claim 3, wherein forming the first estimate of the rotor angle comprises:
calculating a first rotor orientation vector based on the stator flux, the stator current, and one of the known rotor inductance components; and
forming a first estimate based on the first rotor orientation vector, and
wherein forming a second estimate of the rotor angle comprises:
calculating a second rotor orientation vector based on the stator flux, the stator current, and the known other rotor inductance component; and
forming the second estimate based on the second rotor orientation vector.

17. The method according to claim 3, wherein forming the first estimate of the rotor angle comprises:
calculating a first rotor orientation vector based on the stator flux, the stator current, and one of the known rotor inductance components; and
forming a first estimate based on a ratio between an x component and an y component of the first rotor orientation vector, and
wherein forming a second estimate of the rotor angle comprises:
calculating a second rotor orientation vector based on the stator flux, the stator current, and the known other rotor inductance component; and
forming a second estimate based on a ratio between an x component and a y component of the second rotor orientation vector.

18. The method according to claim 3, comprising:
estimating a rotor speed of a synchronous reluctance motor based on the estimated rotor orientation.

19. A computer readable medium having a program code stored thereon, and causing a computer to execute a method of estimating a rotor orientation of a synchronous reluctance motor having a stator and a rotor, wherein an inductance of the rotor in rotor coordinates is represented by a known rotor quadrature axis inductance component (L_{q}) and a known rotor direct axis inductance component (L_{d}), and wherein the method comprising:
determining a stator flux and a stator current;
forming a first estimate of the rotor orientation based on the stator flux, the stator current, and one of the known rotor inductance components;
forming a second estimate of the rotor orientation based on the stator flux, the stator current, and the other of the known rotor inductance components;
determining values for weighting parameters; and
determining the rotor orientation based on the first estimate and the second estimate, wherein the values of the first and second estimates are weighted based on the weighting parameters.

20. The computer readable medium according to claim 19, wherein the value for the weighting parameter is determined based on an orientation represented by an angle between a rotor direct axis and the stator flux.
